(19) United States
(12) Patent Application Publication
(10) Pub. No.: US 2008/0080204 A1
(43) Pub. Date: Apr. 3, 2008

(54) Molded panel and method of manufacture

(75) Inventors: Dimitri Baudon, White Lake, MI (US); Thomas Prevost, West Bloomfield, MI (US)

Correspondence Address: KAPLAN GILMAN GIBSON & DERNIER L.L.P., 900 ROUTE 9 NORTH, WOODBRIDGE, NJ, 07095, US

(73) Assignee: Faurecia Interior Systems U.S.A., Inc., Auburn Hills, MI (US)

(21) Appl. No.: 11/474,194

(22) Filed: Jun. 23, 2006

(51) Int. Cl. G02B 6/00

(52) U.S. Cl. 362/551

(57) ABSTRACT

A method is provided for forming a generally opaque panel with integral translucent areas. An opaque first liquid material is introduced onto the surface of a translucent film provided in a molding tool, and the first material, when cured, bonds to an area on the surface of the film. A translucent second liquid material is then introduced onto the translucent film in a second area, other than the one area. The surface of the translucent film to which the liquid materials have been introduced then becomes the interior surface of the panel. The resulting panel has a translucent front layer and, on its rear surface, an opaque material and a translucent material are formed into difference sections on a single layer.

### BACKGROUND OF THE INVENTION

The present invention relates generally to a panel of the type utilized in motor vehicle and a method for its manufacture. More specifically, the present invention involves a panel of the type commonly used for dashboards, which include an illuminated section.

Illuminated panels are commonly used for the interior of motor vehicles. Panels used for dashboards typically have illuminated sections. FIG. 1 illustrates a typical construction for achieving an illuminated section. Panel 10 is typically provided with an opening 10′ with a light source L mounted behind it. The opening 10′ is formed by a recessed flange 12, and a light pipe section 14 is fitted within the recessed flange 12. A light pipe section 14 may be translucent, or it may be a light diffuser. A shortcoming of, this type of construction is that there is poor fit and finish between the light pipe and panel surface (e.g., at 16), resulting in a product with inferior appearance. There is therefore a need for improving the quality of illuminated panels.

### SUMMARY OF THE INVENTION

In accordance with one aspect of the invention, a shaped panel is formed with a translucent front layer and, on its rear surface, an opaque material and a translucent material are formed into difference sections on a single layer.

In accordance with another aspect exemplified by a first embodiment of the invention, a method is provided for forming a generally opaque panel with translucent areas. An opaque first liquid material is introduced onto the surface of a translucent film provided in a molding tool, and the first material, when cured, bonds to an area on the surface of the film. A translucent second liquid material is then introduced onto the translucent film in a second area, other than the one area. The surface of the translucent film to which the liquid materials have been introduced then becomes the rear surface of the panel. It will be appreciated that a light source may be aligned behind the translucent area. The illuminated panel has a uniform surface which is free of the poor fit finish characteristic of conventional panels. In accordance with another aspect of the invention, the second liquid material may be made of polycarbonate and formed to define a light guide.

In accordance with yet another aspect of the invention, an electroluminescent film or fiber optic web is placed onto the translucent film before the introduction of any liquid material. A liquid material is then provided thereover which, when cured, bonds the surface of the translucent film to the electroluminescent film or fiber optic web.

In accordance with another aspect of the invention, an LED is placed on the translucent film prior to the introduction of any liquid material. A liquid material is then provided thereover which, when cured, bonds to the surface of the translucent film and the LED.

### BRIEF DESCRIPTION OF THE DRAWINGS

The foregoing brief description and further objects, features, and advantages of the present invention will be understood more completely from the following detailed description of presently preferred, but nonetheless an illustrative, embodiments in accordance with the present invention, with reference being had to the accompanying drawings, in which:

FIG. 1 is a schematic representation of a typical prior art illuminated panel;

FIG. 2 is a schematic representation of the initial steps of preferred process for making an illuminated panel in accordance with a first embodiment of the present invention;

FIG. 3 is a schematic representation of the remainder of the process for making the illuminated panel;

FIG. 4 is a schematic representation of the resulting illuminated panel;

FIG. 5 is a schematic diagram representing a method for the manufacture of a second embodiment of illuminated panel in accordance with the present invention, in this case including an embedded illuminating element;

FIG. 6 is a schematic representation of an illuminated panel manufactured by the process illustrated in FIG. 5;

FIG. 7 is a schematic representation of a process for manufacturing a third embodiment of an illuminated panel in accordance with the present invention, in this case the panel including an embedded LED module;

FIG. 8 is a schematic representation of a panel manufactured in accordance with the process illustrated in FIG. 7; and

FIG. 9 is an electrical schematic diagram illustrating the details of the LED and induction modules.

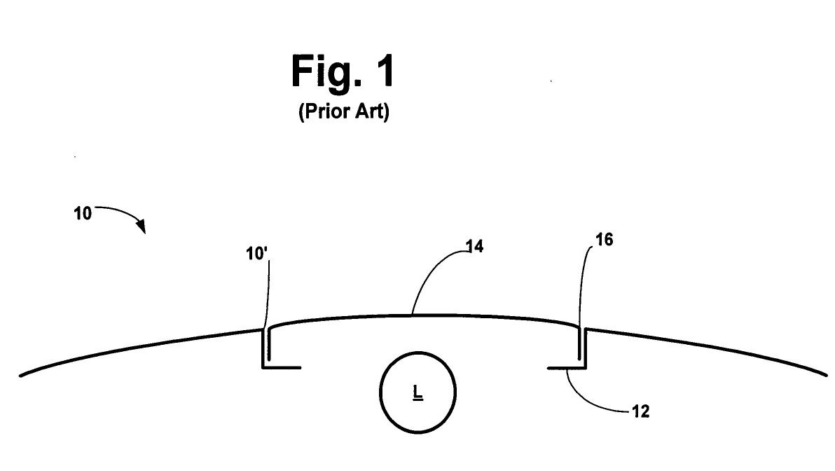

### DETAILED DESCRIPTION OF THE PREFERRED EMBODIMENT

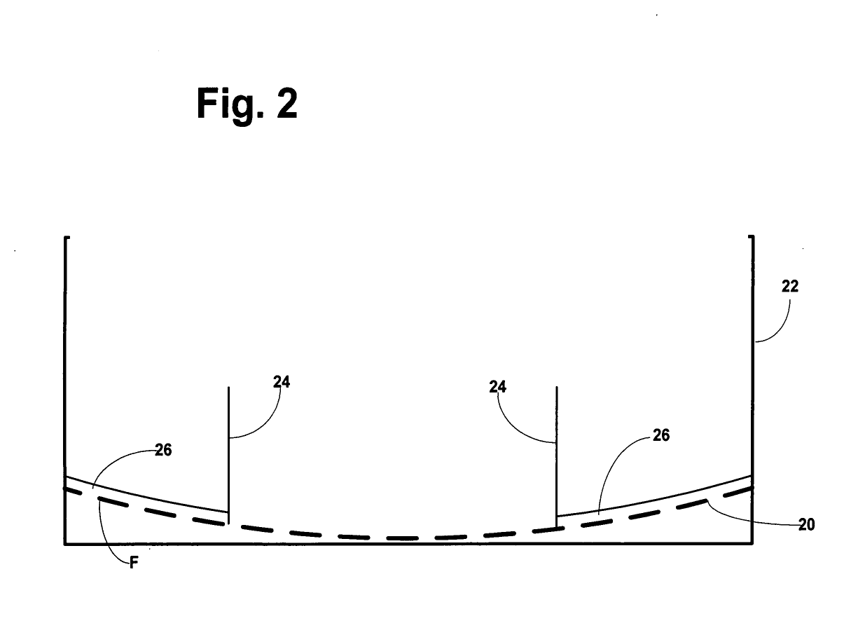

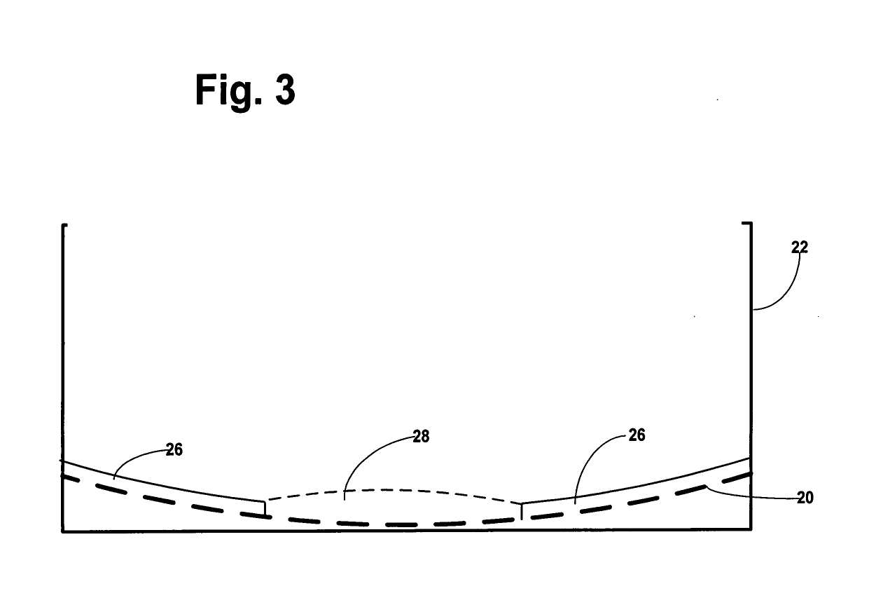

FIGS. 2 and 3 are schematic representations of a process for manufacturing improved illuminated panels in accordance with an embodiment of the present invention. Initially, the translucent film 20 is formed in the desired exterior shape of the panel. In FIG. 2, the exterior or front surface is the bottom surface and the interior and rear surface is the top surface. Preferably, the translucent film is a polycarbonate film, and it may have a finish formed on its exterior or interior surface, as by printing. After film 20 is introduced in molding tool 22, separators 24, 24 are inserted into molding tool 22 and an opaque liquid material 26 is introduced onto the rear surface of translucent film 20. Preferably, material 26 is a polycarbonate acrylonitrile butadiene styrene (PCABS), and it constitutes the substrate of the panel. When the material 26 is cured, it bonds to the rear surface of film 20 in the areas in which it was applied. Thereafter, as illustrated in FIG. 3, the separators 24, 24 may be removed and a second liquid material 28, preferably a translucent polycarbonate light pipe material, is introduced to the rear of film 20 in the area which is not covered by material 26. When material 28 is cured, it bonds to the rear of film 20 in the area not covered by material 26, the two areas now defining a continuous layer.

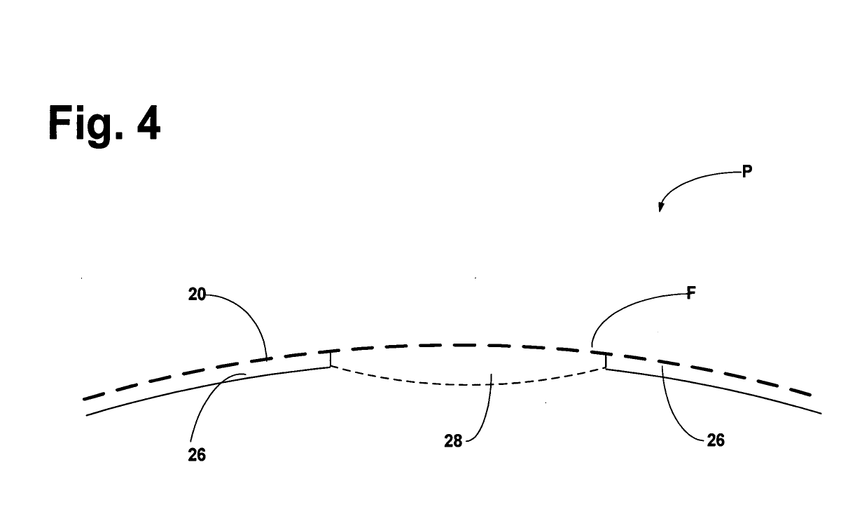

The result is an integral panel with the desired finish, an opaque substrate 26 and, where the material 28 has been introduced, there is a translucent “window”. The resulting Panel is illustrated in FIG. 4.

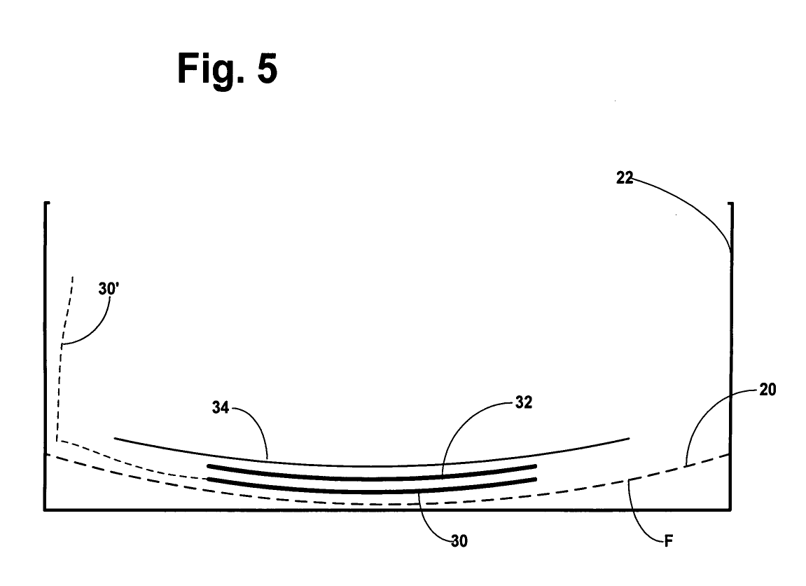

In accordance with another aspect of the invention, an illuminated panel with integral illumination and its method of manufacturer are provided. FIG. 5 is a schematic representation of the method of manufacture of such a panel. A polycarbonate film substrate is placed into the molding tool 22. As was the case previously, film 20 may have a finish on its exterior or interior surface, which may be, for example, a printed layer of ink. On top of the film 20, there is applied an illumination element 30. Element 30 may be either an electroluminescent film or a fiber optic woven web. In either case, a pigtail 30′ is brought out of element 30 and allowed to penetrate the many layers that are formed on top of film 20. For example, if element 30 is an electroluminescent film, the pigtail 30′ will contain the necessary electrical connections. Alternately, if element 30 is a fiber optic woven web, pigtail 30′ will contain the fibers through which light is provided to the element 30.

On top of element 30, there is formed a backing layer 32 which is constructed to reflect light, so that light emitted from element 30 will all be in the direction of film 20. Layer 32 may be chemically compatible with polypropylene and its derivatives or it may be compatible only with polycarbonate or polycarbonate acrylonitrile butadiene styrene.

On top of the proceeding layers, an injection molded layer 34 is formed so that the element 30 is sandwiched between the film 20 and the injection molded material 34.

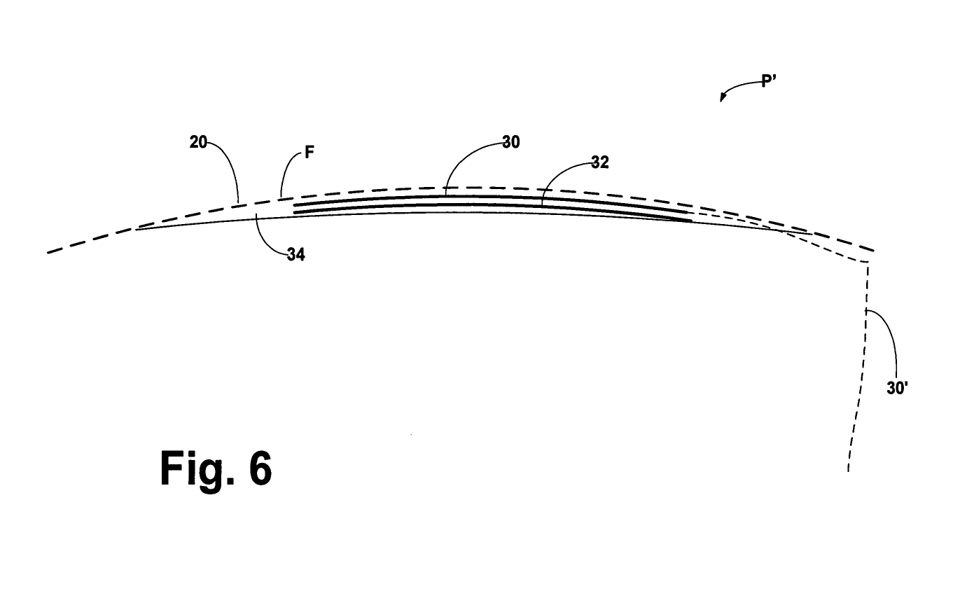

The resulting panel P′ is illustrated in FIG. 6. In the completed panel, the illuminating layer 30 and the backing 32 are sealed between the film 20 and the injection molded material 34. This provides a durable, one-piece panel P′.

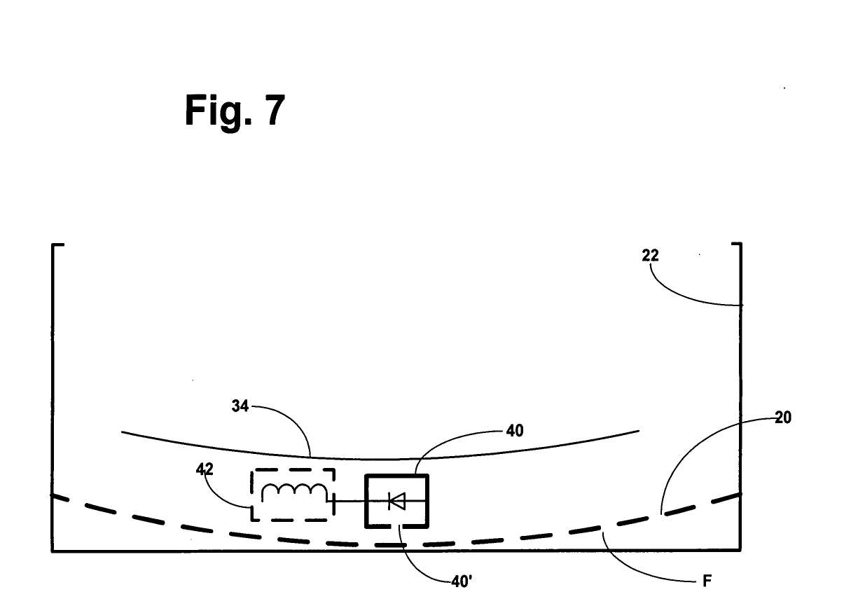

FIG. 7 is a schematic representation of the method of manufacture of a further alternate embodiment in accordance with the present invention. In this case, an illuminated panel is made which contains an embedded LED module. As was the case previously, a polycarbonate film 20 is provided in the molding tool 22. Preferably, the film 20 has a finish on its exterior (or interior) surface. If desired, a central portion of film 20 may be left unfinished in order to provide a window through which illumination from the LED module may emanate.

An LED module 40 with a connected induction coil module 42 are placed upon the film 20. The LED module 40 has an illumination window 40′ which may be aligned with the window in film 20, if provided. The module 42 is provided in order to power LED 40 wirelessly, as will be explained further below. However, it will be appreciated that, alternately, a pigtail connection could be provided to LED 40 in a manner similar to FIG. 5.

On top of elements 40 and 42, an additional layer 34 of material is injection molded so that, when cured, it bonds to the top surface of the film 20, the LED module 40, and the coil 42, effectively sealing in the elements 40 and 42.

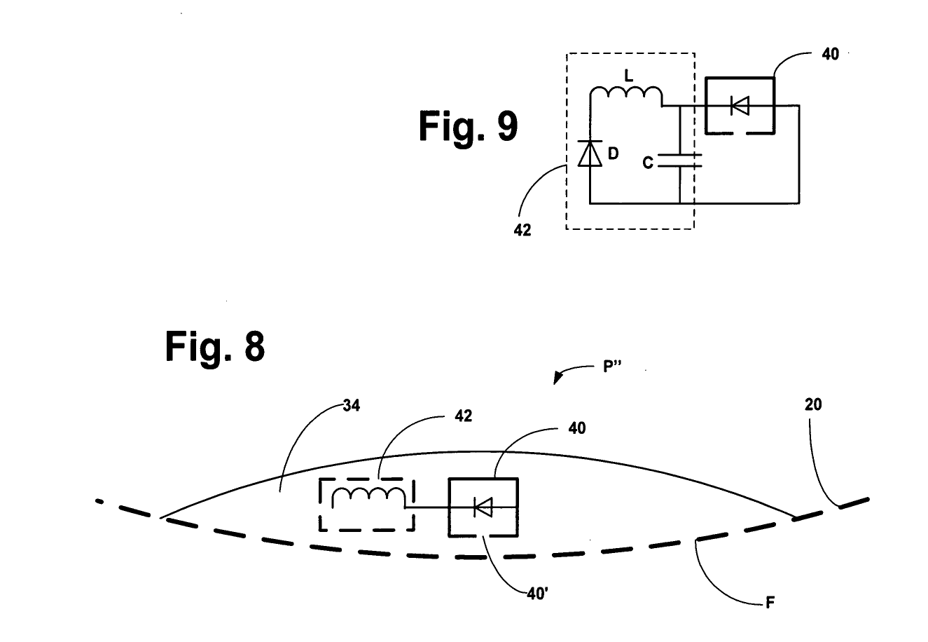

The resulting panel is illustrated in FIG. 8. The LED module 40 and induction module 42 are effectively sealed between film 20 and injection molded material 34. The LED module 40 may be powered by bringing a transmitting coil (not shown) into the vicinity of coil 42. A voltage is then induced in coil 42. In order to make use of the induced voltage to power the LED, it is rectified. The rectifying circuitry constitutes a diode D driving a capacitor C, with the powering voltage to module 40 being provided across the capacitor C. It will be appreciated that the diode and capacitor will be sealed along with the inductor 42 as induction module 42.

As shown in FIG. 9, the voltage induced in inductor 42 charges capacitors C through diode D when diode D is conductive. When the induced voltage reverses, diode D turns off and leaves capacitor C charged, with the LED 40 continuing to be powered from the capacitor.

As can be seen in FIG. 8, the panel P′ is an integral, sealed unit and can be conveniently illuminated by mounting a driving coil in the vicinity of coil 42.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. A method for manufacturing a panel, said panel being generally opaque but having at least one translucent area, said method comprising the steps of:
introducing a first liquid material onto a surface of a translucent film disposed in a molding tool, said first liquid material being constituted to bond to a first area of the surface of said translucent film; and
introducing a second liquid material onto an area on the surface of the translucent film other than the first area, said second liquid material being constituted to bond to the area on the surface of said translucent film to which it is introduced;
one of said first and second liquid materials being opaque and the other being translucent.

2. The method of claim 1 wherein one of the liquid materials is constituted to require curing in order to bond to its respective area of said translucent film.

3. The method of claim 1, wherein the opaque material is PCABS.

4. The method of claim 1, wherein the translucent material is polycarbonate.

5. The method of claim 1, further comprising the step of printing a finish on a surface of said translucent film prior to the placing step.

6. The method of claim 1 wherein the introducing steps are performed so that said first and second materials comprise a single layer on said film.

7. The method of claim 6, further comprising the steps of:
inserting at least one separator into the molding tool before the step of introducing said first liquid material so as to prevent said first liquid material from contacting a predefined area on the surface of said translucent film; and
removing said at least one separator from the molding tool after said first liquid material is introduced.

8. The method of claim 7 wherein the first liquid materials is constituted to require curing in order to bond to its respective area of said translucent film, the at least one separator, being removed after said first liquid material is cured.

9. The method of claim 7 wherein the introducing steps are performed so that said first and second materials comprise a single layer on said film.

10. The method of claim 1, further comprising the steps of:
inserting at least one separator into the molding tool before the step of introducing said first liquid material so as to prevent said first liquid material from contacting a predefined area on the surface of said translucent film; and
removing said at least one separator from the molding tool after said first liquid material is introduced.

11. The method of claim 10 wherein the first liquid materials is constituted to require curing in order to bond to its respective area of said translucent film, the at least one separator, being removed after said first liquid material is cured.

12. The method of claim 10 wherein the introducing steps are performed so that said first and second materials comprise a single layer on said film.

13. A method for manufacturing an illuminated panel, comprising the steps of:
placing one of an electroluminescent film and a fiber optic web on a translucent film in a molding tool, said translucent film being shaped to conform to at least one surface of said illuminated panel; and
forming an opaque material onto the translucent film in the molding tool so that said opaque material bonds to said translucent film and also bonds to said one of an electroluminescent film and a fiber optic web.

14. The method of claim 13 wherein said forming step is injection molding.

15. The method of claim 13 wherein the opaque materials is constituted to require curing in order to bond to said translucent film, or said one of an electroluminescent film and a fiber optic web.

16. The method of claim 13, further comprising, before said forming step, introducing a reflective layer on said one of an electroluminescent film and a fiber optic web, said opaque material bonds to said reflective layer.

17. A method for manufacturing an illuminated panel component, comprising the steps of:
placing an LED module onto a translucent film in a molding tool, said translucent film being shaped to conform to at least one surface of said illuminated panel; and
forming a material onto the translucent film in the molding tool so that said material bonds to a surface of said translucent film and to the LED module.

18. The method of claim 17 wherein said forming step is injection molding.

19. The method of claim 17 wherein the opaque materials is constituted to require curing in order to bond to said translucent film or said LED module.

20. The method of claim 17, further comprising, before said forming step, placing an induction module onto the translucent film and connecting it to power the LED module.

21. A panel which is generally opaque but has at least one translucent area, said comprising:
a translucent film;
a first material bonded to a first area on a rear surface of said translucent film; and
a second material bonded to an area on the rear surface of said translucent film other than the first area, the second material being on a common layer with the first material;
one of said first and second materials being opaque and the other being translucent.

22. The panel of claim 21 wherein the opaque material is PCABS.

23. The panel of claim 21 wherein the translucent material is polycarbonate.

24. The panel of claim 21 wherein a surface of the translucent film has a surface finish formed thereon.

25. An illuminated panel, comprising:
a translucent film;
one of an electroluminescent film and a fiber optic web disposed on the translucent film;
an opaque material bonded to said translucent film and said one of an electroluminescent film and a fiber optic web.

26. The panel of claim 25, further comprising a reflective layer interposed between. said opaque material and said one of an electroluminescent film and a fiber optic web, said opaque material bonding to said reflective layer.

27. The panel of claim 25 wherein the opaque material is PCABS.

28. The panel of claim 25 wherein the translucent material is polycarbonate.

29. The panel of claim 25 wherein a surface of the translucent film has a surface finish formed thereon.

30. The panel of claim 29 wherein said surface finish omitted in an area on said translucent film to define a window therein.
